(19) United States
(12) Patent Application Publication
(10) Pub. No.: US 2024/0348054 A1
(43) Pub. Date: Oct. 17, 2024

(54) Electrolyzer Systems and Methods of Operation for Supporting Stability of a Power Grid

(71) Applicant: Stiesdal Hydrogen A/S, Give (DK)

(72) Inventors: Thomas Holm Krogh, Klovborg (DK); Karsten Schibsbye, Fredericia (DK)

(21) Appl. No.: 18/676,863

(22) Filed: May 29, 2024

Related U.S. Application Data
(63) Continuation of application No. PCT/DK2022/050258, filed on Dec. 2, 2022.

(30) Foreign Application Priority Data
Dec. 8, 2021 (DK) PA 2021 01164

(51) Int. Cl. H02J 3/14; C25B 1/04; C25B 15/02; H01M 8/0656; H02J 3/38; H02J 15/00

(52) U.S. Cl. CPC H02J 3/144; C25B 1/04; C25B 15/02; H01M 8/0656; H02J 3/381; H02J 15/008; H02J 2203/10; H02J 2300/20

(57) ABSTRACT

An electrolyzer system is provided for supporting stability of the power grid by three modes. In a first mode, the consumption is regulated in the direction of stabilizing the grid. In a second mode, an electrical capacitor effect of the electrolyzer is used with quick discharge temporarily in reverse for counteracting short-time power deviations in the power grid. In a third mode, the electrolyzer shifts to a short-term fuel cell mode consuming the gases at the electrodes. For example, all three modes are triggered, one after the other.

### CROSS-REFERENCE TO RELATED APPLICATIONS

This application is a continuation under 35 U.S.C. 111 of International Patent Application No. PCT/DK2022/050258, filed Dec. 2, 2022, which claims the benefit of and priority to Danish Application No. PA 2021 01164, filed Dec. 8, 2021, each of which is hereby incorporated by reference in its entirety.

### FIELD OF INVENTION

The present invention relates to electrolyzer systems and methods of operating such systems. In particular, this disclosure relates to use of electrolyzer systems to support stability of a power grid.

### BACKGROUND

In large electric utility grids, an increasing portion of the power is produced by inverter-based systems. Such systems do not inherently contribute to the grid inertia in the same way as synchronous generators powered by fossil fuel inherently contribute, and this increases the risk of voltage and frequency fluctuations. Maintaining a stable grid frequency and voltage on an electric grid based on primarily renewable sources such as photovoltage, wind power, water power, and battery technology will require active functions and control strategies to ensure that the grid frequency and voltage is maintained.

As the grid transitions from predominantly fossil fuel sources to a grid with predominantly renewable fuel sources, there will be periods with a very high percentage of the power produced by renewable and with a very small number of fossil plants connected to the grid. Such periods pose a special challenge to the grid operators and may require that conventional fossil plants stay connected, not for generating energy but mainly for grid stabilization reasons. Some mitigations have already been developed for renewable energy sources, addressing this issue, like wind turbine frequency response and wind turbine based inertial response. These functions improve the grid stability, but due to the mechanical aspect of the functions, deploying these with very fast response times can have a serious impact on the wind turbine, so there is a cost or a lifetime implication for the operators. Frequency response to low frequency requires some level of curtailment, and inertial response of turbines introduces an issue of a recovery delay after the initial energy response, reducing the value of the frequency stability contribution from wind turbines to some degree.

Periods when the renewable penetration is the highest are also periods when the energy prices tend to be low, so for energy storage systems, this would be the ideal time to charge or store energy.

From a grid-stability perspective, the frequency deviation from the nominal grid frequency represents an imbalance between the power delivered into the grid and the power being extracted from the grid. Any over-frequency, which is a frequency above the design frequency, is a result of more energy flowing into the grid than is actively being consumed, and any under-frequency is a result of more energy being extracted from the grid than what is flowing into the grid at that point in time. A typical response to under-frequency on a fossil grid is managed by the inherent inertia provided by synchronous generators, and on the larger time scale, additional power is provided by ramping up spinning reserve capacity.

In order to facilitate the transition from a fossil economy to a renewable economy, electrolyzers, such as an alkaline electrolyzer system, can be used to convert electrical energy to hydrogen when the energy prices are low. Energy storage by production of hydrogen for later use in a power plant is disclosed in European patent application EP2318678A1. A hydrogen production system using power from wind farms is disclosed in international patent application WO2010/048706A1, including power balancing controllers for weak electrical grids. By intelligent control of the electrolyzer, it can also contribute to the frequency stability on the larger grid at the same time without mechanical risk or damage.

The prior art discusses adjustment of the electrical consumption by electrolyzers relative to the availability of electricity at low costs, as well as adjustment of the consumption in order to contribute to stabilization of the grid, for example including the possibility to ramp the consumption up or down relative to a predetermined set point. For example, WO2006/072576, WO2014/037190, and WO2013/004526 disclose methods where the load to the network is adjusted by extending or reducing the number of electrolyzers in a system.

Chinese patent application CN112165108A discloses a power grid auxiliary peak regulation system including electrolyzers for hydrogen production as well as lithium batteries. Japanese patent application JP2021136709 A2 discloses energy storage of solar power by batteries and hydrogen production.

US2016/369416 and US2016/377342 disclose a reversible fuel cell system that can switch between electrolyzer function with a corresponding production of hydrogen gas and fuel cell function for production of electrical power, which can be used to stabilize the grid. A similar relatively slow acting reversible system for grid stabilization is disclosed in US2016/372775 and AU2021100419A4.

Such switch is useful for slow variations in the grid but cannot be used for stabilization of the network at short time scale, where spikes or drops in the network occur within time frames of a second or less.

Additionally, the prior art discusses feeding current back into the grid for stabilizing reasons by using fuel cells that consume the earlier produced hydrogen. However, these measures for grid stabilization are relatively slow and include some time lag and hysteresis when it comes to electrical variations in the grid.

### BRIEF DESCRIPTION

It is therefore an objective of the present systems and methods to provide an improvement in the art. In particular, it is an objective to provide an electrolyzer system that can be used for quick grid power stabilization within a fraction of a second. This objective and further advantages are achieved with an electrolyzer system and a method of its operation as described below and in the claims.

In short, the electrolyzer system is supporting stability of the power grid by three modes. In a first mode, the consumption is regulated in the direction of stabilizing the grid. In a second mode, an electrical capacitor effect of the electrolyzer is used with quick discharge temporarily in reverse for counteracting short-time deviations in the power grid of frequency or voltage or both. In a third mode, the electrolyzer shifts to a short-term fuel cell mode consuming the gases at the electrodes. For example, all three modes are triggered, one after the other.

The electrolyzer imports energy from the grid to split water into hydrogen and oxygen, which then can be used for other purposes, for example, for energy storage and later conversion back to electrical energy by fuel cells. During operation, the functionally connected inverter can be configured to support the grid voltage. In addition, a method of controlling the electrolyzer such that the electrolyzer can reverse its functionality to contribute to grid stability when needed is disclosed. Accordingly, the device is used not only to convert energy to gas but due to its energy storage capability can also actively contribute to grid frequency and voltage stability.

Advantageously, and as exemplified in the following, the electrolyzer is an alkaline electrolyzer. During a conventional mode of operation, the alkaline electrolyzer is controlled such that it is activated for gas production at a pre-set level when power from the grid is available and when the operator wishes to produce gas, and the electrolyzer is disconnected again when gas production is not possible or desirable, for example when it is not profitable.

As envisioned, an alkaline electrolyzer, adjusts the power consumption according to the availability of power in the grid, potentially taking into regard the profitability as well. For example, if the electrolyzer is connected to a photovoltaic (PV) system, it will be operated to consume high power when the sun is shining, and shut its productivity down at night.

As will become apparent from the following, an electrolyzer is provided that comprises a stack of electrolyzer modules for producing hydrogen gas from water, each module comprising a pair of electrodes sandwiching a membrane therebetween. Further, an inverter system is electrically connected to the stack of modules and electrically connected to an electrical power grid. For the control of the inverter system and the electrolyzer, a control system is functionally connected to the inverter system.

Grid support, as described in the following, is generally relevant. The alkaline electrolyzer has the possibility of reacting to grid behavior in three different modes. In particular, the electrolyzer system is configured for electrically supporting the power grid by three different support modes during power deviations from a predetermined operation state of the grid for counteracting the deviations.

In a first support mode A, the electrolyzer system is configured for varying import of electrical energy from the grid in response to the deviations. In this first mode, the alkaline electrolyzer can support instability in the grid by reducing or increasing the power consumption according to the conditions of the grid. For example, in the morning, when private consumers are using large amounts of electrical power, the power consumption by the electrolyzer system is reduced. The consumption can then be adjusted to full power, when sufficient power is available and when the grid is functioning stably, and especially when the power is available at low costs.

This adjustment can be done by the control system through automatic monitoring of the actual grid frequency and voltage and by adjustment of the power, accordingly. Alternatively, or additionally, the control system is interfaced to the grid operator and receives information and/or even commands through the interface. As a further optional measure, consumption pricing is taken into regard by the controller, which in this case is receiving actual pricing levels and/or pricing forecasts in order to plan and regulate the consumption based on multiple parameters, potentially using artificial intelligence in order for the controller to learn grid behavior and potentially forecast consumption profiles as well as delivery profiles. For example, the controller takes into account weather forecasts when the electrolyzer is used in a grid with a substantial portion of the power delivered by PV or wind turbines.

In principle, the electrolyzer can be operated in a standard mode at a fraction of its maximum capacity, for example half capacity, and then ramped up or down as a stabilizing action for the grid. However, this implies operating the electrolyzer at less than maximum capacity most of the time, which is not an optimum way of using an electrolyzer. Therefore, different modes of grid stabilization by the electrolyzer have been added.

For electrical grid support, a second mode B is included, which is a fast-acting mode in which the electrolyzer functions as a capacitor. Due to the electrodes of the modules being charged and having a voltage across the membrane in between the electrodes, each module functions as a capacitor, and the stack of electrolyzer modules can function as a series of serially connected capacitors. In this second mode, the modules are switching from an electrically charged operational state to a discharge state, in which the electrical power from the discharge is exported through the inverter into the grid for stabilizing unwanted short term variations of the power in the grid.

When the electrolyzer system is large, the capacitance of the entire stack is substantial and can have a total capacitance up to several milli Farad, which makes it suitable as a substantially sized quick-acting capacitor for short time-scale grid stabilization, especially when used for small grids, for example based on renewable sources, such as wind turbines and/or PV plants.

This ability of electrolyzer systems to act as capacitors for storing electrical energy can advantageously be utilized to support the temporary energy reversal and contribute to grid frequency recovery. In this capacitor function of the electrolyzer system, the grid stabilizing action can be performed at time scales from milliseconds and potentially up to a few seconds.

In practice, in case of faults or incidents in the grid, the electrolyzer will use its inverter and the capacitive effect of the alkaline electrolyzer stack to immediately support the grid to recover by returning bursts of electrical power into the grid. In a millisecond time frame, the alkaline electrolyzer can go from passive consumer of power to a grid-supporting reverse action device, contributing to maintaining the grid in normal operation. Especially in weaker grids, such as micro grids dependent on wind and sunlight, this is critical in order to avoid a total black out. Especially, if the alkaline electrolyzer is a large consumer with a major load in a weak grid, possibly representing several percent of the total grid consumption, it is very critical that this load can be able to react actively to support the grid to recover and not just cut out in case of grid faults.

Although, the functionality of a quick return effect by the electrolyzer into the grid is most pronounced in weak and small grids, it may also be useful in stronger and larger grids. In particular, if the electrical return effects of several electrolyzer systems are combined, even if they have different locations, this functionality can be used to support the grid in maintaining the grid frequency and keep the grid stable.

It should be pointed out that, in stronger grids, electrolyzers, such as alkaline electrolyzers, can also be installed with the direct purpose of stabilizing the grid, with the option of manufacturing hydrogen when stabilization is not required. In other words, the electrolyzer can have a stabilizing functionality as the primary function and only be used for hydrogen manufacturing as a secondary functionality. This could then replace other reactive equipment, that traditionally will be used for the purpose, so that, instead of having a fully passive grid support component, the alkaline electrolyzer will be used for manufacturing hydrogen when power is cheap and available, but standing by mainly for its stabilizing purpose.

When a grid goes in brown-out where parts of the grid are disconnected, i.e. due to temporary short circuits, the traditional power sources in the remaining grid will all try to maintain the voltage and frequency, and typically there will be a need of both active and reactive power to avoid a total black out, while the grid couples out the fault. Such incidents can last for several seconds until the fault is cleared, and the remaining grid can continue operation. Typical reaction from large consumers of power will be to cut out the load, which will also be the typical reaction from an electrolyzer.

For such events, the electrolyzer comprises a third mode for grid support, which is explained in the following. In this third support mode C, the electrolyzer system is configured for switching instantly from a hydrogen production mode into a fuel cell mode, wherein gas at the two opposite electrodes of the electrolyzer module from the immediately preceding hydrogen production is converted back into water inside the module.

During normal operation of the electrolyzer, gas resides on the surface of the electrodes and between the electrodes. This residual oxygen and hydrogen gas can be used for conversion back into water with a reversal of electrical energy flow. This fuel cell mode of the electrolyzer, without providing a separate fuel cell but merely using the reverse function across the already existing electrolyzer electrodes and membrane, is then used for feeding energy back to the grid as long as there is gas available near the electrodes for the fuel cell function. Thus, the gas is already located at the electrodes and does not have to be transported to the electrodes from storage tanks. Although, the amount of energy originating from this relatively small amount of gas is correspondingly small, its capture and export to the grid is sufficient for a stabilizing action in the range of a second and in certain cases up to 10 seconds, further extending the duration and/or magnitude of the energy exported in response to a grid frequency dip.

In practical embodiments, the electrolyzer system is configured for electrically supporting the power grid by the three different support modes one after the other with the first mode A reducing the power import to zero, then reversing power back into the grid within milliseconds in support mode B, then continuing reverse flow of electricity into the grid by fuel cell action in mode C, and then, after recovery of the grid, returning to consumption for gas production.

Accordingly, when combining mode B and mode C of recovery action, the electrolyzer may as a first step react instantly to variations in the grid by feeding power back into the grid through the inverter in the time frame of milliseconds by using the capacitive effect. As a second step, if necessary for further stabilizing the grid, the alkaline electrolyzer is set to consume the gas close to the electrodes in a fuel cell mode, and the correspondingly produced power is then fed reverse into the grid through the inverter to support the grid through a low voltage incident.

In practice, the electrolyzer system is triggering a recovery sequence for power support of the grid. In this sequence, the electrolyzer system is shifting from mode A to mode B, including reducing import of electrical energy from the grid to zero in the first support mode A, and then switching to the second support mode B with a capacitor function of the modules, in which the modules are switching from an electrically charged operational state to a discharged state, and exporting the discharge electrical power through the inverter into the grid for stabilizing unwanted short term variations of the power in the grid.

If the fast recovery action by the second mode is sufficient to return the grid to normal operation, the third mode C need not be activated, irrespective of the fact that the system is capable of doing so.

Therefore, after performing the recovery sequence, the system checking whether the grid has recovered and in the affirmative, it is returning to power consumption and production of hydrogen gas.

However, if the grid has still not recovered, and the check reveals that further recovery action is necessary after mode B, the system is extending the recovery sequence by shifting from mode B to mode C and operating the electrolyzer modules as fuel cells that are consuming gas at the two opposite electrodes of the electrolyzer module and feeding the electrical power produced in this fuel cell mode through the inverter into the grid until the gas at the electrodes is consumed.

The recovery sequence may be based on measurements that the electrolyzer system does on the grid. Alternatively, or in addition, the control system of the electrolyzer system comprises a data interface for receiving external data for receiving digital trigger data from an external data provider, for example the operation system of the grid or from a central controller that is in data communication with other electrolyzer systems. The trigger data advantageously comprise information about the actual state of the grid. However, it may also, or alternatively, comprise information about expected future states of the grid. These data can then be used for starting a recovery action for the grid automatically on the basis of the trigger data.

For the triggering, various parameters can be used by the electrolyzer system. For example, it may be programmed to trigger a recovery mode for power support of the grid in dependence of measured parameters, the parameters including frequency of the grid and/or voltage of the grid. The measured parameters can be provided to the controller by measuring the conditions in the grid at the electrolyzer system, or the measurement data are received from an external source through the data interface.

Opposite a wind turbine, where a grid support reaction may result in heavy mechanical load, the chemistry in the recovery action will have no mechanical impact to the alkaline electrolyzer, as the whole process is a purely electrical behavior, initially, and then a chemical behavior.

In weak grids, for example minor grids based on renewable energy plants, the capability to ride through instabilities is very important in order to maintain a stable grid operation. By utilizing the electrolyzer actively for returning power to the grid in cases of improper grid behavior, instead of considering it as a passive consumer, the overall grid complexity is reduced as well as the need for additional components for grid stability. Even in strong and potentially larger grids, the electrolyzer can also support the grid, especially if multiple electrolyzer plants are used for a coordinated action through a correspondingly programmed main control system, even if the electrolyzer plants are located apart, as long as they are connected to the same grid.

Selecting a fully controllable inverter technology instead of a traditional thyristor-based inverter makes it possible to completely control the energy flow from being a consumer, importing energy for its main purpose, to a power supporter by also allowing export of power.

This ability to both import and export energy enables the system to respond to both fast and slow frequency events or frequency dips on the grid side and, instead of merely adjusting the gas production, the system as described herein has the additional advantage of temporarily extracting energy from the electrolyzer in different modes with corresponding different time constants and feed this energy back to the grid in order to compensate for a drop in frequency.

Rates of change of power for import and export are suitably provided as programmable response curves in terms of at least one of time, time delay, ramp rates, duration, frequency impact, proportionality, magnitude and response profiles.

The fast response time and the ability to change power direction can also be used in association with Black Start and Block Loading where incrementally larger and larger loads are connected to the grid being brought online. When each new load is connected, it will have an impact on the grid frequency, and the electrolyzer's ability to ramp power fast without excessive mechanical loads will offer superior ramping capability and grid stability support compared to a fossil fuel generator or a renewable plant.

In the following, a dimensional example is given for purpose of illustration without limiting the general character of the invention. For example, the following parameters are valid.

For example, the direct current (DC) voltage from module to a subsequent module is 1.4 V. As an example, the electrode area is in the range of square meters. As the number of modules in a stack can range from hundreds to thousands of modules, the resulting voltage is in the kV range. Such systems are capable to substantially supporting micro grids in the range of tens of MW.

The above numbers show that the electrolyzer system with its different assisting recovery modes for the grid is a substantial support factor for micro grids.

If several of such systems are used in combination, even if remotely spaced, even larger grids can be supported.

### BRIEF DESCRIPTION OF THE DRAWINGS

The invention will be explained in more detail with reference to the drawings, where:

FIG. 1 is a simplified system diagram, according to an embodiment;

FIG. 2 illustrates reactive power control as a first mode of operation, according to an embodiment;

FIG. 3 illustrates second and third modes of operation, according to multiple embodiments;

FIG. 4 is an illustration of frequency dependent power import or power export, according to an embodiment;

FIG. 5 illustrates a response to a grid frequency drop during a period with max power import, according to an embodiment; and

FIG. 6 illustrates voltage drop control, according to an embodiment.

### DETAILED DESCRIPTION

In FIG. 1 an alkaline electrolyzer system 1 is illustrated that comprises one or more stacks, here shown with two stacks 2 of electrolyzer modules 3. Each of the modules 3 comprises two electrodes 4 on opposite sides of a membrane 5. The modules 3 in a stack 2 are electrically connected to each other in series, and the two stacks 2, and potentially additional stacks, are connected in parallel to an inverter system 6, which in turn is connected to the electrical power grid 7 by a grid connection 8. The inverter system 6 and the operation of the electrolyzers in the system 1 is controlled by a control system 9 having a digital data interface 10 for remote data exchange.

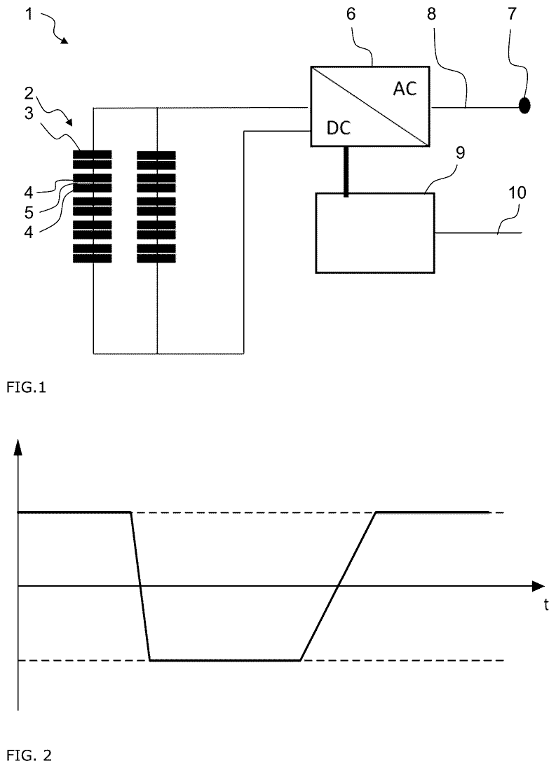

FIG. 2 illustrates a first mode of operation of the electrolyzer with time along the X-axis and power import relative to a set point along the Y-axis. In this first mode, of operation, the electrolyzer is set to work under predetermined conditions, for example maximum hydrogen production as long as the grid works in optimum or at least acceptably stable conditions. However, if the capacity of the grid decreases, the consumption/import of power is reduced, until the grid is working again appropriately, at which time, the consumption is ramped up again.

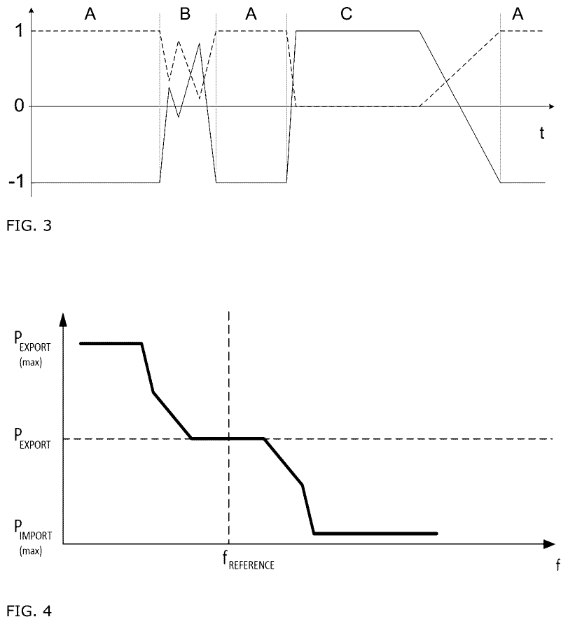

FIG. 3 illustrates some principles of a second mode B and a third mode C of operation by the alkaline electrolyzer in order to support grid stability. The X-axis represents time t, and the Y-axis represents arbitrary normalized units related to grid power and power imported or exported by the electrolyzer system. The upper curve, which is stippled, illustrates a grid power behavior, and the lower curve, which is solid, illustrates the import and export of power by the electrolyzer system. The diagram of FIG. 3 illustrates three different regimes, A, B, and C. The regimes labeled A illustrate normal operation, which is usually the case and may last from hours to months and where also the electrolyzer is running in normal operation for production of hydrogen gas. In this regime, the electrolyzer may consume power from the grid up to a maximum value for maximum hydrogen production or to an otherwise set maximum for power to be imported from the grid. The maximum value is arbitrarily set to 1, and since it is an import of energy from the grid, the value given in the illustration for the electrolyzer curve in the regime A is minus one. For illustrative purposes in relation to the curve, however, the scale or values are not important, as the curve solely reflects the principle.

In the second regime, B, the grid power exhibits some short drops, for example drops in the voltage. These drops are short, lasting a minor fraction of a second, such as few or tens of milliseconds. In order to counteract these short drops in power, the electrolyzer system with its inverter is programmed to react quickly to not only reduce consumption but even export power into the grid by using its natural fast-reacting capacitive effect. This export of energy is illustrated by the solid curve in the positive regime of the vertical axis.

As mentioned above, the electrodes of the electrolyzer modules are charged with a voltage across the membrane so that modules function as capacitors, and the stack of electrolyzer modules can function as a series of serially connected capacitors. Accordingly, this ability of electrolyzer systems to act as capacitors for storing electrical energy can advantageously be utilized to support the temporary power reversal into the grid and contribute to grid recovery.

The capacitive effect by the electrolyzer can be of an intensity that substantially reduces the power drop in the grid and possibly even eliminates the power drop in the grid. This would be the case if the electrolyzer is of a substantial size relative to the power grid, for example a microgrid. Especially, several electrolyzer systems, may be even at various locations, may be connected through the data interface for cooperation in order to counteract drops in the grid by combined efforts.

In the regime C of FIG. 3, the grid has a brown out on the order of a second. In this case, the capacitive export effect of mode B would be quick to counteract the initial drop but not long lasting enough for stabilizing the network for a length of a second. Therefore, the electrolyzer system is changing into a third mode of operation C, in which it functions as a fuel cell using the gas available in the cell.

As discussed above, during normal operation, gas resides on the surface of the electrodes and between the electrodes, which can be used in a fuel cell mode for conversion of the gas into water. The produced electricity from the conversion of the residual gas is then used for feeding energy back to the grid as long as there is gas available in the fuel cell to function. For a grid stabilizing action on the order of a second or some seconds, this third mode is useful. Notice that no separate fuel cell is provided, and the gas used for the fuel cell effect is only the gas at the electrodes and not gas supplied from a gas storage facility, as the latter would not act fast enough.

The control algorithm for performing the frequency response is provided in the control system 9, which can be combined with the inverter system 6 or be provided as a separate control unit in electronic connection with the inverter system 6.

Trigger levels for when to feed electricity back to the grid and in what form and which mode is, as an option, defined by local parameter settings at the location of the electrolyzer. In this case, the control system would take into account the electricity state of the grid, for example as measured or as received through the data interface. Alternatively, trigger data and levels are received through the data interface by remote signals transmitted to the controller from a remote location, for example from a power plant operator, or from a master controller that controls more than one electrolyzer system with respect to grid support.

In order to use the electrolyzer system in an optimum way for grid support, the control system, advantageously, has multiple types of pre-programmed or commanded responses in terms of response times, response magnitude, response durations and/or response profiles.

Various combinations of trigger functions may involve not just specific levels but also take into account time of week or day as well as grid or commercial aspects, such as electricity pricing.

Additionally, the control system may use artificial intelligence in order to optimize responses to unwanted grid power variations, where the program uses experience of the variations to learn how to provide optimum responses and reverse power for grid stability.

For example, the grid is stabilized in dependence of the frequency, and the control system is programmed to support frequency stability in the grid by injecting short term energy back to the grid during frequency drops.

As illustrated by the drop curve in in FIG. 4, electrical power P_{EXPORT} is exported back into the network, or electrical power P_{IMPORT} is imported from the grid, depending on the frequency in the grid deviating from a reference frequency f_{REFERENCE}.

The criteria for decisions as to whether the operation is in a mode for power import or power export can be based on linear relationships with a corresponding predetermined parameter, such as grid frequency, but need not be so. Any predetermined function that is commercially or technically beneficial in relation to the power exchange can be used as an option. Additionally, the correction function can be enabled or disabled as needed based on commercial considerations or agreements with the grid provider or based on a technical grid state.

As it appears from this example, the system can be configured for operating at a power set point with a frequency drop curve applied for adjusting the resulting power output in response to the grid frequency, measured or provided from external equipment. The drop can be applied to power references in the entire power range of the electrolyzer, both power export and power import. The power direction will be restored automatically when the right combination of criteria is present.

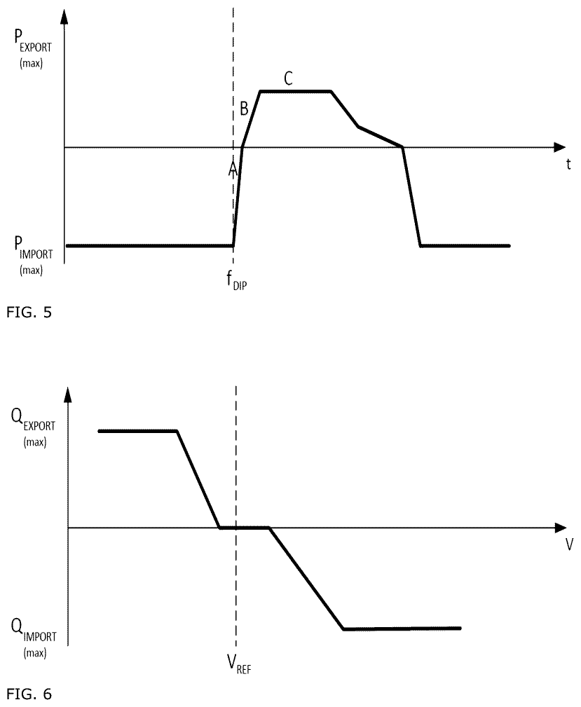

FIG. 5 illustrates a response to a grid frequency drop during a period with max power import. Triggered by a certain frequency change threshold f_{DIP} for the frequency drop, the import of energy is stopped, and power is exported to support the grid. Immediately after the frequency threshold has been passed, the consumption is decreased to zero according to the first mode A of function where power is only imported when the grid is able to deliver power under stable conditions. This is illustrated by the power curve in FIG. 5 rising from the negative max import level of power, P_{IMPORT (max)}, to zero.

The first portion of exported power, illustrated by the first linear curve portion into the positive region is due to the capacitance effect in the second mode B. After exhaustion of the capacitance effect, the electrolyzer system enters the fuel cell effect in the third mode C. This third mode C has only a short duration, namely until the gas at the electrodes is used up, so that the power export is soon exhausted and returns to zero. If the grid has recovered at this stage, the electrolyzer system can start importing power again, which is shown to the right in the curve, decreasing to the max import power P_{IMPORT (max)}.

An action as a response to a frequency drop in the grid to below a setpoint frequency, i.e. an under-frequency event, can be triggered due to a measurement of the frequency or triggered by an under-frequency event command to the control system 9 through the data interface 10 from a remote location, for example a remote control system or remote control station of a power plant.

In such event, the power import may be ramped to a new set point according to an assigned ramp rate or response profile. The power export is maintained as per the assigned profile in terms of magnitude and duration until the profile has been executed or the stored energy has been exhausted. When the grid frequency has recovered sufficiently, the electrolyzer will resume gas production following a ramp rate for the power import.

FIG. 6 illustrates a voltage drop curve, where the voltage of the grid relative to a reference voltage VREF determines whether power is exported or imported.

The alkaline electrolyzer is able to support the grid voltage and frequency as soon as it is in operation. The grid assistance of the electrolyzer increases the value of the design from an end consumer perspective because the device combines functionality that today may be provided by multiple individual devices. For example, it is possible to build or upgrade a wind power plant with an electrolyzer of this type and save substation power correction system or capacitor banks.

The alkaline electrolyzer can directly receive voltage or reactive power references from a plant controller to meet the combined reactive power or voltage requirements and at the same time be used to produce gas.

In summary, the electrolyzer system has dual function as a hydrogen production facility and as a stabilizing factor for a power grid. In the stabilizing function, it operates according to three modes. In a first of the three stabilizing modes, the consumption is regulated in the direction of stabilizing the grid. In a second mode, an electrical capacitor effect of the electrolyzer is used with quick discharge temporarily in reverse for counteracting short-time power deviations in the power grid. In a third mode, the electrolyzer shifts to a short-term fuel cell mode, consuming the gases at the electrodes. Such an electrolyzer system is advantageously used as an energy storage plant as part of a grid recovery system, in addition to producing hydrogen gas.

What is claimed is:

1. An electrolyzer system comprising:
a stack of electrolyzer modules for producing hydrogen gas from water, each module comprising a pair of electrodes sandwiching a membrane therebetween;
an inverter system that is electrically connected to the stack of electrolyzer modules and electrically connected to an electrical power grid;
a control system that is functionally connected to the inverter system for controlling the inverter system;
wherein the electrolyzer system is configured for electrically supporting stability of the power grid by three different support modes during power deviations from a predetermined operation state of the power grid for counteracting the power deviations;
wherein the electrolyzer system in a first support mode A is configured for varying import of electrical energy from the power grid in response to the power deviations;
wherein the electrolyzer system in a second support mode B is configured for capacitor function of the electrolyzer modules in the stack, wherein the electrolyzer modules switch from an electrically charged operational state to a discharged state, wherein the electrical power from discharging is exported through the inverter into the power grid for stabilizing unwanted short-term variations of the power in the power grid; and
wherein the electrolyzer system in a third support mode C is configured for switching instantly from a hydrogen production mode into a fuel cell mode, wherein gas at the electrodes of the electrolyzer module is combined through the membrane and converted back into water inside the module.

2. The electrolyzer system according to claim 1, wherein the three different support modes are carried out one after the other with the first support mode A reducing the power import to zero, then reversing power back into the power grid within tens of milliseconds in the second support mode B, then continuing reverse flow of electricity into the power grid by fuel cell action in the third support mode C, and then, after recovery of the power grid, returning to consumption for the hydrogen gas production.

3. The electrolyzer system according to claim 1, wherein the electrolyzer system is programmed to trigger a recovery mode for power support of the power grid in dependence of measured parameters, the parameters including frequency of the power grid.

4. The electrolyzer system according to claim 1, wherein the electrolyzer system is programmed to trigger a recovery mode for power support of the power grid in dependence of measured parameters, the parameters including voltage of the power grid.

5. The electrolyzer system according to claim 1, wherein the control system of the electrolyzer system comprises a data interface for receiving external data, the external data comprising information about at least one of an actual state of the power grid and an expected future state of the power grid.

6. A method of operating an electrolyzer system, the method comprising:
providing the electrolyzer system of claim 1; and
triggering a recovery sequence for power support of the power grid, the recovery sequence comprising shifting from the first support mode A to the second support mode B, including reducing import of electrical energy from the power grid to zero in the first support mode A, and then switching to the second support mode B with a capacitor function of the modules, wherein the modules switch from an electrically charged operational state to a discharged state, and exporting discharged electrical power through the inverter into the power grid for stabilizing unwanted short term variations of the power in the power grid.

7. The method according to claim 6, further comprising, after performing the recovery sequence, checking whether the power grid has recovered and, in the affirmative, returning to power consumption and production of hydrogen gas.

8. The method according to claim 6, further comprising:
receiving trigger data from an external data provider, the trigger data comprising information about at least one of an actual state of the power grid and an expected future state of the power grid; and
starting the recovery sequence for the power grid automatically based on the trigger data.

9. The method according to claim 6, further comprising checking whether further recovery action is necessary after the second support mode B, and in the affirmative, extending the recovery sequence by shifting from the second support mode B to the third support mode C and operating the electrolyzer modules as fuel cells that consume gas at the electrodes of the electrolyzer module and feed the electrical power produced in this fuel cell mode through the inverter into the power grid until the gas at the electrodes is consumed.

10. The method according to claim 9, further comprising:
receiving trigger data from an external data provider, the trigger data comprising information about at least one of an actual state of the power grid and an expected future state of the power grid; and
starting the further recovery action for the power grid automatically based on the trigger data.

11. The method according to claim 9, further comprising after performing the recovery sequence, checking whether the power grid has recovered and, in the affirmative, returning to power consumption and production of hydrogen gas.
